(19) United States
(12) Patent Application Publication
(10) Pub. No.: US 2021/0184759 A1
(43) Pub. Date: Jun. 17, 2021

(54) Device for locating any plane in real time using the internet

(71) Applicant: Manoj Tewari, Franklin, WI (US)

(72) Inventor: Manoj Tewari, Franklin, WI (US)

(21) Appl. No.: 16/714,069

(22) Filed: Dec. 13, 2019

(51) Int. Cl. H04B 7/185; B64D 11/00; G08G 5/00

(52) U.S. Cl. CPC H04B 7/18506; G08G 5/0021; B64D 11/0015

(57) ABSTRACT

Using high performance Internet access from onboard a flying airplane this device will send requisite information like specific coordinates, identity, speed, altitude, time etc. to a designated server/servers. Just like you'd send a text message from your phone while flying at 30000 feet using the Wi-Fi provided by your airplane. This invention will benefit Aircraft manufacturers, airports, aircraft lessors, airlines, airline operators' centers, and government agencies such as the FAA, NTSB, and NWS, etc.

Allow me to borrow an analogy—let's go back in time of the Wright Brothers on Dec. 17, 1903. They flew their plane for about 12 seconds and its top speed was just 26 knots or about 30 MPH, and so there was no practical application of that flight—right!!! WRONG. Looking back it surely showed the possibility that a plane could fly. The Concorde used to fly almost 1350 MPH. That's a BIG leap from 3 MPH to 1350 MPH.

The black box technology of today is akin to that 12 second flight [symbol] while comparing it to this invention/innovation or Mr. Graham Bells phone to today's smart phone you got the idea. There's been an exponential rise in technology.

MH370 was a black swan incident, totally unpredictable; has left everyone baffled. It actually exposed disturbing gaps in communications and security systems of the airplanes. You see once the transponder and ACRS were switched off, the plane was flying like a ghost without any contact with the ground. The satellite communication antenna mounted on the top of MH370 (typically a red light) was sending a periodic beep every hour to a satellite which allows air traffic controller, airline operators and engine manufacturers to know it's still flying and then it stopped after hours of flying aimlessly when it ran out of fuel. The problem is that it does not give a specific location. In the present scenario there exists an urgent need for systems and methods to improve upon and altogether replace several existing technologies/practices like use of Might Data recorder, cockpit voice recorder and Black box etc. win a more robust and dynamic system.

When a plane goes missing, authorities go searching by hunch and available hints (think MH 370).

No need to do that anymore, this invention is the perfect solution that uses the state of the art technology presently available in almost all airlines namely the internet. More and more airlines are adding Internet as a standard feature like the bottled water being served for free on a flight—soon to become ubiquitous. The aircraft manufacturers just have to install a few of these devices on each plane for knowing among other things where exactly a plane was at a given point in time during a flight—in REAL TIME.

MCU is short for microcontroller unit—MCU's are tiny programmable computer processors: measuring mm across, low powered, ultra-cheap, some as small as the head of a pin that can be built and embedded in infinite number of devices, some for mere pennies, these miniature computing devices need only mill watts of electricity effectively meaning that it can run for years on a miniscule battery or even a small solar cell. So now it's possible to make a Webserver that will fir on a fingertip for around a dollar. These MCU's will get data from all kind of sensors (minute devices capable of monitoring anything that can possibly be measured and recorded, including temperature, altitude, speed, power, location, radiation, atmospheric pressure, rotation, sound, magnetic force even video will be found all around us in practically everything). Microcontrollers are dedicated to one task and typically run one specific program. The program is stored in ROM (read-only memory) and generally does not change. A microcontroller has a dedicated input device and often (but not always) has a small LED or LCD display for output. A microcontroller also takes input from the device it is controlling and controls the device by sending signals to different components in the device. For example, the microcontroller inside a TV takes input from the remote control and displays output on the TV screen. The controller controls the channel selector, the speaker system and certain adjustments on the picture tube electronics such as tint and brightness power it on/off etc. You got the drift.

I suspect that this invention in times to come will become even more miniaturized, even become the size of a MCU and could be used in the tires of airplane or the landing lights, or on the airplanes windscreen or who knows even in a Bicycle tire or its handle—you get the drift. Thinking of Moore's law . . . but I am thinking that there will be an explosion with 5 G coming to life and IOT booming . . . .

The landscape of connected objects will change BIG TIME and this invention will be used in cars, boars, refrigerators, sofas, pillows the list is practically endless. But in reference to this invention, it'll just gather a few selected parameters, send them via airplanes' internet to the designated servers at a certain intervals. The whole idea is to put couple of our devices in hard to reach places of an airplane and some areas impossible to reach while the plane is flying. So the information is flowing freely and I'm assuming that some of the internet modems on the plane are placed in hard to reach areas too; meaning they cannot be turned off midflight.

A single sentence explanation of the figures

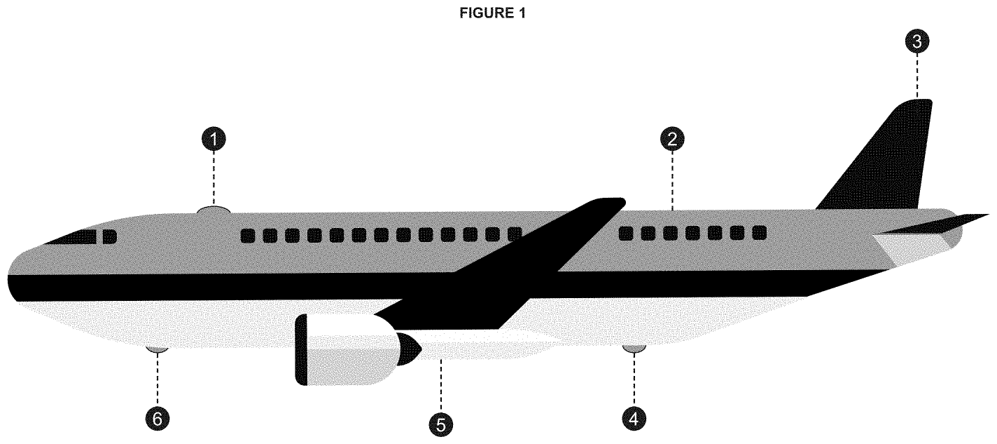

FIG. 1

Shows typical areas on an internet ready plane where the repeaters are installed and our device would use a few of these to send our data.

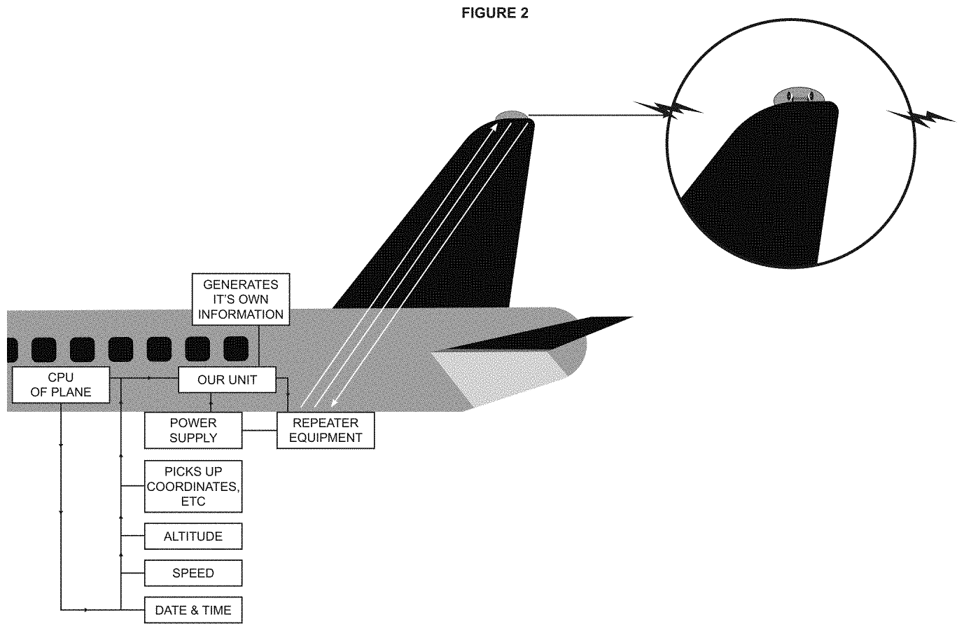

FIG. 2

How the device will work

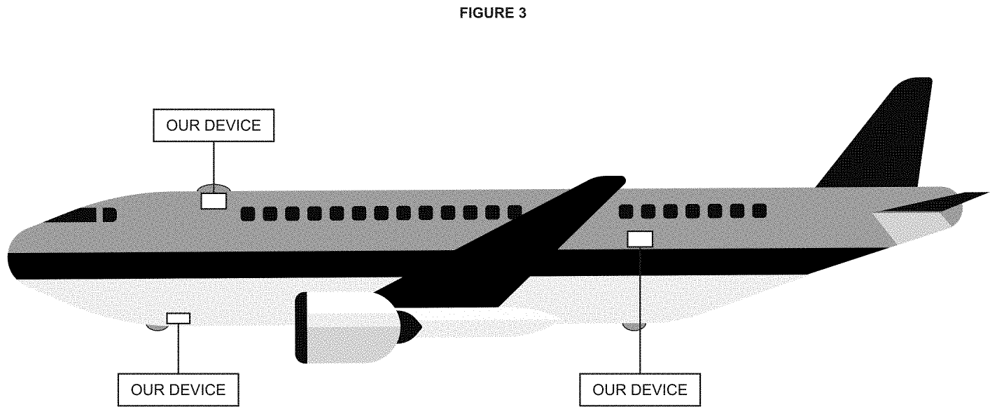

FIG. 3

Suggested places where the device can be installed

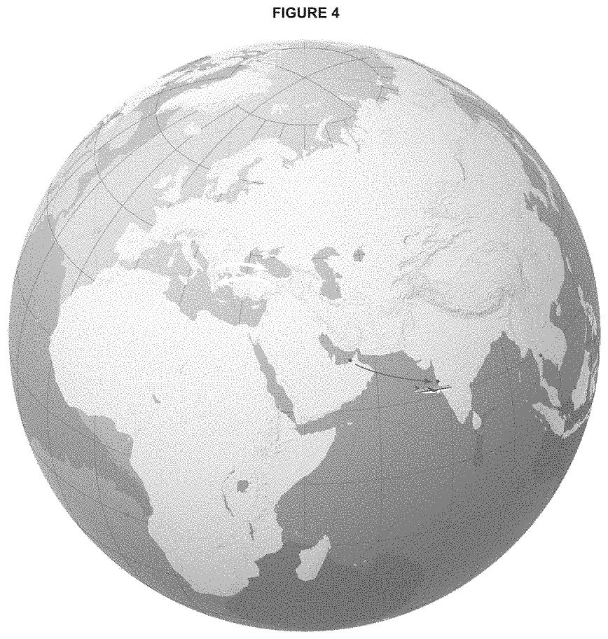

FIG. 4

Show how the coordinates etc. with tell where the plane is at a certain point in time.

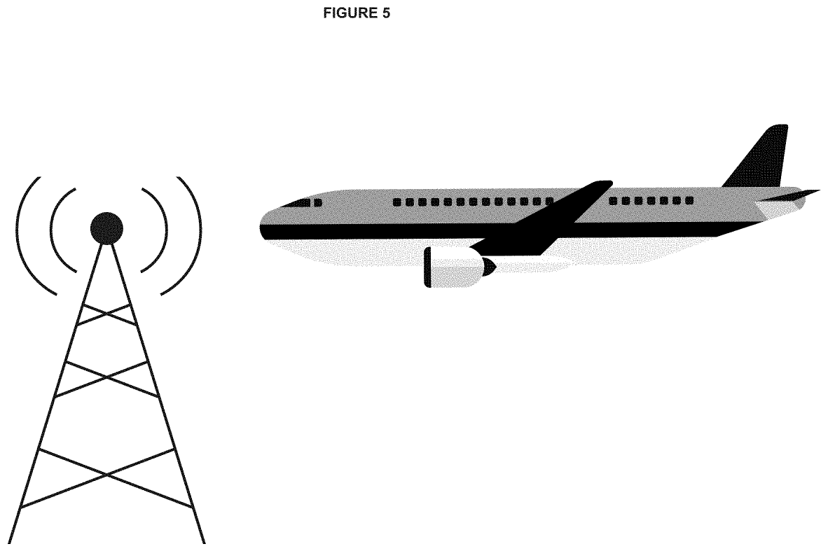

FIG. 5

Shows the tower sending the internet signal to the plane

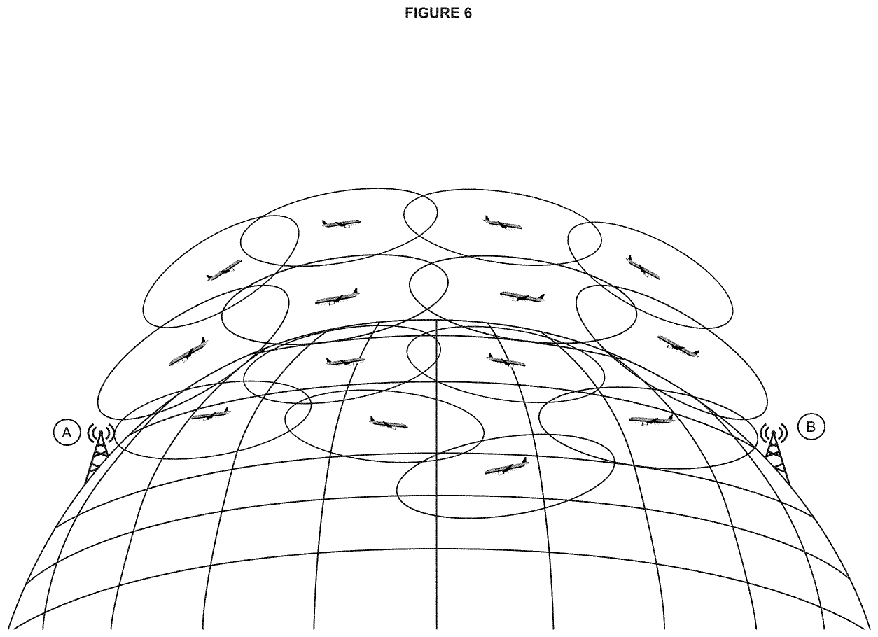

FIG. 6

Shows how/the planes will act as signal carriers & or how the airplane internet corridor works

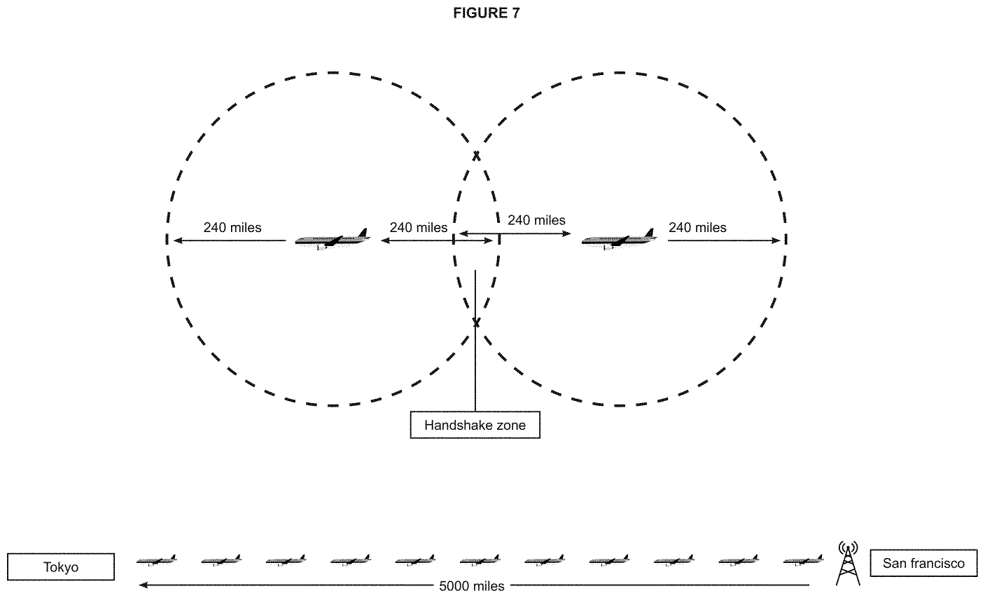

FIG. 7

Shows how far the airplane signal typically goes and how it works with shaking hands from one end to another.

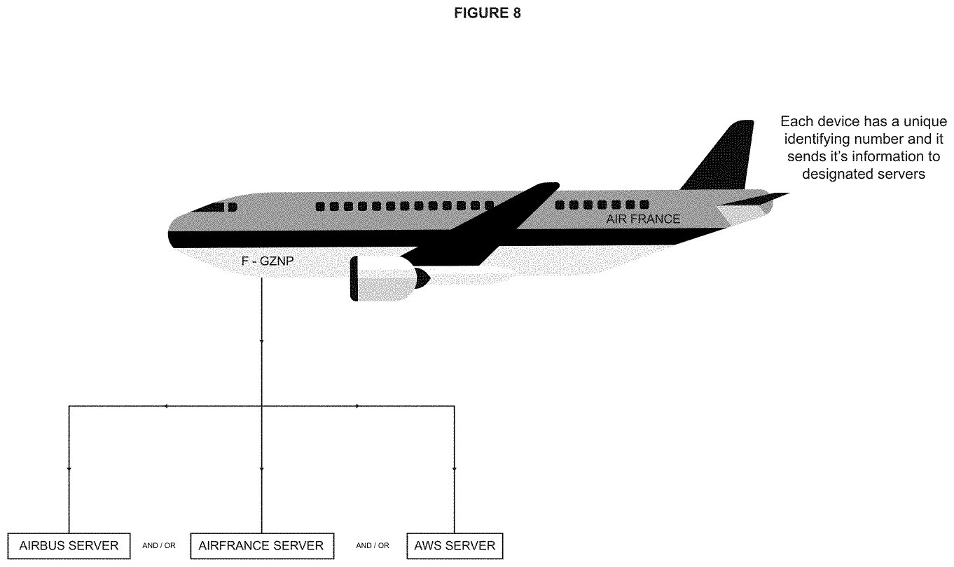

FIG. 8

Figure shows how each device will have a separate unique identification pertain to that planes unique registration

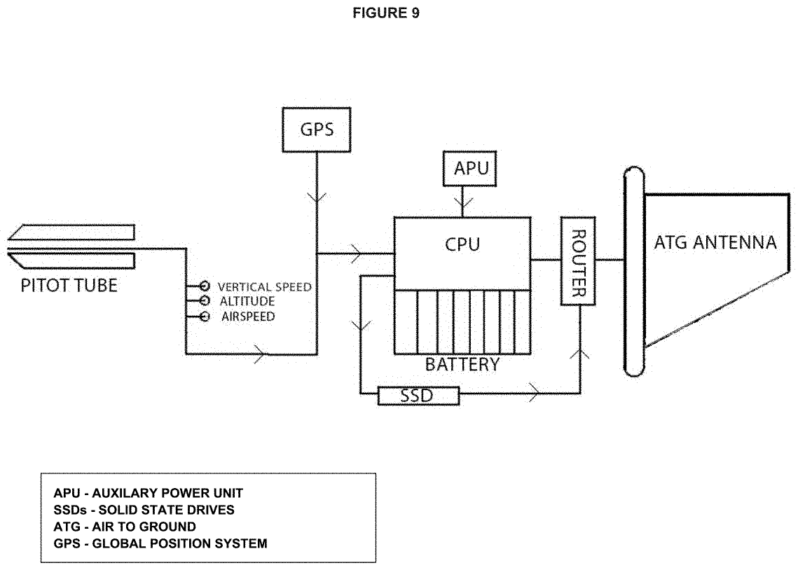

FIG. 9

How the device will work in terms of picking up data from the airplane and what are the major components of the device.

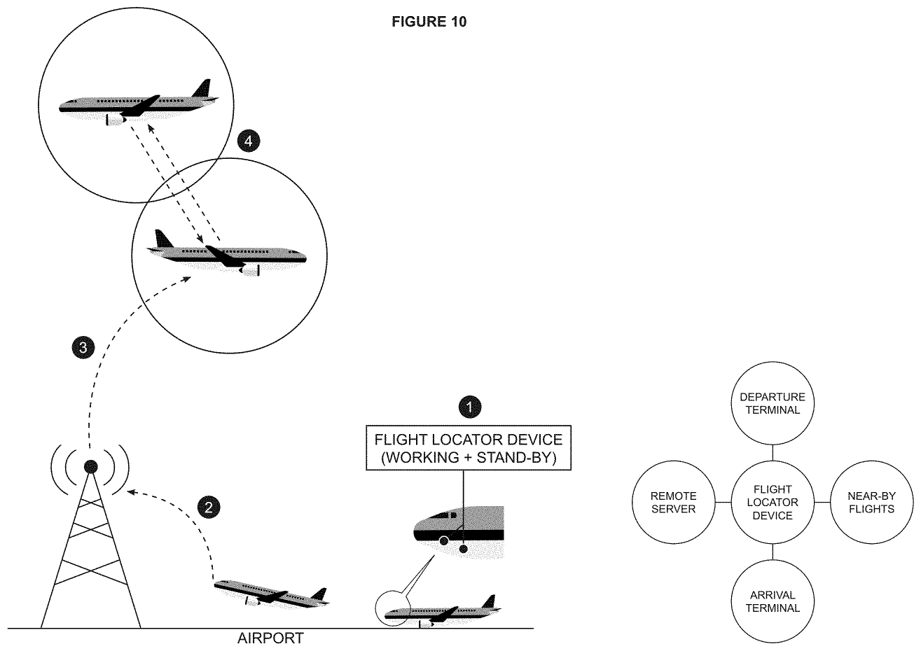

FIG. 10

Shows the working of the device in a nutshell

Reference cited {by Pat. No. & Title}

| Pat. No. | Title |
|---|---|
| 10,405,143 | Systems and methods for autonomous equipment operation where |
| | GPS not available |
| 10,367,773 | Social network based on GPS and other network connections |
| 8,473,620 | Interception of a cloud-based communication connection |
| 10,338,089 | System and method for determining speed of a vehicle based on GPS |
| | speed |
| 9,813,969 | In-flight cellular communications system coverage of mobile communications |
| | located in aircraft |
| 10,412,100 | System and methods for providing secure data connections in an |
| | aviation environment |
| 10,321,517 | System and method for connecting aircraft to networks on ground |
| 10,291,313 | Method and apparatus for data communication utilizing the North |
| | American terrestrial system |
| 10,102,753 | Systems and methods for processing flight information |
| 9,973,263 | Integrated communication and application system for aircraft |
| 9,934,620 | System and method for crowd sourcing aircraft data communications |
| 10,453,277 | Vehicle monitoring system that dynamically varies data acquisition |
| US20190263339 | Sensing systems and methods |
| (Pat. | |
| application | |
| Pub.) | |
| 10,405,143 | Systems and methods for autonomous equipment operation where |
| | GPS not available |
| 10,367,773 | Social network based on GPS and other network connections |
| 8,473,620 | Interception of a cloud-based communication connection |
| 10,338,089 | System and method for determining speed of a vehicle based on GPS |
| | speed |
| 9,813,969 | In-flight cellular communications system coverage of mobile communications |
| | located in aircraft |
| 10,412,100 | System and methods for providing secure data connections in an |
| | aviation environment |
| 10,321,517 | System and method for connecting aircraft to networks on ground |
| 10,291,313 | Method and apparatus for data communication utilizing the North |
| | American terrestrial system |
| 10,102,753 | Systems and methods for processing flight information |
| 9,973,263 | Integrated communication and application system for aircraft |
| 9,934,620 | System and method for crowd sourcing aircraft data communications |
| 10,453,277 | Vehicle monitoring system that dynamically varies data acquisition |
| US20190263339 | Sensing systems and methods |
| (Pat. | |
| application | |
| Pub.) | |

1. The information packages can be created based on what information is required & configured.

2. The information could be speed.

3. The information could be just coordinates.

4. The information could be altitude.

5. The information could be air temperature etc.

6. The information could be a bunch of parameters mentioned above or anything else thought of to be included.

7. The device could also be connected with an Ethernet cable; meaning if the cable fails the wireless connectivity keeps sending the information packages to the designated servers or vice versa.
The difference between this invention and other similar products is that they use satellite to send data and if the transmission is stopped the flow of information is stopped. While this invention/devices will be placed in different areas of the plane (strategic) some hard to reach areas while in flight and will use Wi-Fi or the internet on the airplane.
In flight entertainment—refers to different entertainments available to aircraft passengers during a flight. Starting from the time of the airship Hindenburg passengers were offered amenities like onboard piano, lounge, dining room, even a smoking room, and bar during the 2½ day flight between Europe and America. Nowadays, if people have internet 24-7 they are happy, as it allows them to connect with their favorite apps/social media like Snap Chat, Instagram, facebook, Twitter or checking their emails, watching stuff on YouTube. Doing things in real time for example posting a live feed/video of inflight altercation of a passenger. The list is practically endless.
This invention can easily fit inside the modem that provides the in-flight internet. More like a 2 in 1.
Internet onboard an airplane is more or less like an In-Flight entertainment offering in today's world.
In a way, it will keep sending information about the device itself (which is flying within the airplane). The information it'll be sending will be gathered from the airplane.
